(19) United States
(12) Patent Application Publication
(10) Pub. No.: US 2015/0186631 A1
(43) Pub. Date: Jul. 2, 2015

(54) COMPUTER KEYBOARD WITH ARTICULATED ULTRASONIC USER PROXIMITY SENSOR

(71) Applicants: Philip J. Bruno, Oakland, CA (US); Robert A.D. Schwartz, Oakland, CA (US); Paul Schwartz, Oakland, CA (US)

(72) Inventors: Philip J. Bruno, Oakland, CA (US); Robert A.D. Schwartz, Oakland, CA (US); Paul Schwartz, Oakland, CA (US)

(21) Appl. No.: 14/645,274

(22) Filed: Mar. 11, 2015

Related U.S. Application Data
(63) Continuation-in-part of application No. 13/652,732, filed on Oct. 16, 2012.
Application No. 13/652,732 is a continuation-in-part of application No. 13/136,358, filed on Jul. 28, 2011.

(51) Int. Cl. G06F 21/31; G06F 3/02

(52) U.S. Cl. CPC G06F 21/31; G06F 3/0219

(57) ABSTRACT

A computer keyboard supports an ultrasonic user presence detector (UPD) that is rotatable and supported on the upper surface of the keyboard, adjacent to the uppermost row of keys and located adjacent to one corner of the keyboard. The UPD is aimed at an elevation of 20°, and rotates to sweep through an angle of approximately +35° to −20° to be selectively directed toward the most-likely position of an individual using the keyboard, so that the proximity detection error rate is very low. In one embodiment the UPD housing is rotatably supported on a modular interchangeable top secured to the keyboard at the upper margin thereof adjacent to the uppermost row of keys.

### CROSS-REFERENCE TO RELATED APPLICATIONS

This application is a continuation-in-part of U.S. application Ser. No. 13/652,732, filed Oct. 16, 2012, which claims the benefit of filing date priority based on U.S. application Ser. No. 13/136,358, filed Jul. 28, 2011, which claims filing date priority based on Provision Application No. 61/369,301, filed Jul. 30, 2010.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a keyboard for use with a computer system, particularly a computer system that requires secure log-in arrangements and the ongoing presence of the logged-in individual at the keyboard.

2. Description of Related Art

As computer systems have become more and more essential to the operation of businesses and institutions, there has been a concomitant increase in the number of terminals, work stations, desktop computers and the like that are connected to the computer system that serves the business or institution. One of the many uses of a central computer system is the storage of records that should be held confidential, such as medical data regarding individuals, personnel records, financial records and transactions of the business or institution, payroll records, and the like. For this and other reasons there is a definite need for some form of security system to limit access to confidential information, not to mention access to computerized functions such as payroll, billing, and the like. On the other hand, it is necessary to grant access of some sort to a large number of individuals so that they may carry out their assigned tasks which often involve interaction with the computer system. The confluence of the requirement for confidentiality and the need to grant access has lead to a proliferation of security measures and systems that are designed to recognize individuals who are authorized to have access to the computer system and at least some portion of its records and functions, while denying access to those individuals who endeavor to gain access to the system without authorization.

The most common security devices and measures currently in use include passwords assigned individually to each employee, biometric sensors such as fingerprint readers, iris scanners, facial recognition, and the like, electronic scanners such as RFID or NFC-RFID for security cards or badges, and auto locking sonar transceivers to detect whenever an authorized individual leaves the vicinity of the computer or terminal where authorized access took place. See for example the description of an auto-locking sonar system in U.S. application Ser. No. 13/136,358, filed Jul. 28, 2011, which is incorporated by reference herein in its entirety. In this system the ultrasonic user presence detector is mounted on the keyboard that is used in conjunction with a computer system or computer terminal, and is aimed in a fixed direction toward the expected position of the keyboard user.

However, it has been observed that in some situations the keyboard user may move laterally away from the keyboard while continuing to use the keyboard and wanting to remain logged in to the system. For example, making or answering a telephone call in an office setting may entail moving away from the axis of the detector. In a medical setting, operators of medical test equipment may use one hand to operate the test device while entering control commands and data on the keyboard with the other hand. Likewise, it is now commonplace for medical personnel to interview and examine a patient while entering data into a keyboard to generate accurate electronic medical records as information is developed. Such movement away from the user detector axis may easily cause the system to command a log-out, requiring the user to log in to the system repeatedly. This is both inefficient and annoying to the user.

### BRIEF SUMMARY OF THE INVENTION

The present invention generally comprises a computer keyboard for use with a terminal or workstation or desktop computer setup. A salient feature of the keyboard is that it supports an ultrasonic user presence detector (UPD) that is rotatable and may be aimed by the user as needed when the user changes locations adjacent to the keyboard.

In one preferred embodiment, the UPD comprises an ultrasonic detector that is a transceiver that emits an ultrasonic beam and detects reflected energy returned to the transceiver. The ultrasonic detector is mounted in a small housing that is rotatably supported on the upper surface of the keyboard, adjacent to the uppermost row of keys and located adjacent to one corner of the keyboard. The ultrasonic detector is aimed at an elevation angle of approximately 20°. The housing is rotatable and may be selectively directed to sweep through an included angle of approximately +35° to −20° with respect to an axis extending transversely to the midpoint of the keyboard. In this way the sensor is directed toward the most-likely position of an individual using the keyboard, so that the proximity detection error rate is very low.

In another embodiment the invention provides a keyboard assembly having a unique modular system, designed to have custom-designed interchangeable tops to accommodate various discrete input technologies, as described in copending U.S. application Ser. No. 13/652,732, filed Oct. 16, 2012, which is incorporated herein in its entirety. This modular design is tooled to accommodate up to seven different combinations of technologies, as well as the UPD described above. In this embodiment the UPD housing is rotatably supported on a flexible interchangeable top that is secured to the keyboard at the upper margin thereof adjacent to the uppermost row of keys. The housing is rotatable and may be selectively directed to sweep through an included angle of approximately +35° to −20° with an axis extending transversely to the midpoint of the keyboard. In this way the sensor may be directed toward the most-likely position of an individual using the keyboard, so that unintended log-out from the system is avoided.

### BRIEF DESCRIPTION OF THE DRAWING

FIG. 1 is a plan view showing one embodiment of the angularly articulatable ultrasonic user proximity sensor of the present invention.

FIG. 2 is an exploded perspective view showing the major components of the articulatable ultrasonic user proximity sensor of the invention.

FIG. 3 is a plan view of one embodiment of the invention in which the articulatable ultrasonic user proximity sensor is mounted on a replaceable, customizable keyboard cover.

FIG. 4 is an enlarged partial perspective view of the keyboard cover depicted in FIG. 3.

FIG. 5 is a perspective view of the bottom of the outer housing component of the invention.

FIG. 6 is a perspective view of the bottom of the component assembly of the articulatable ultrasonic user proximity sensor.

### DETAILED DESCRIPTION OF THE INVENTION

The present invention generally comprises a computer keyboard for use with a terminal or workstation or desktop computer setup. An important aspect of the keyboard is an ultrasonic user presence detector (UPD) extending from the upper surface thereof and that is rotatable to be aimed by the user as needed when the user changes position adjacent to the keyboard.

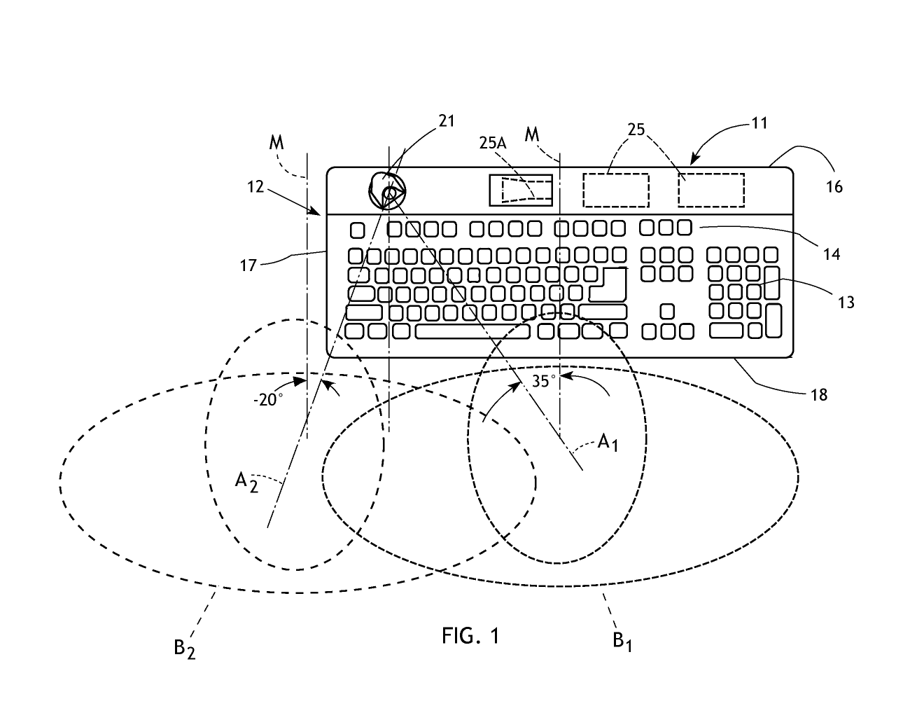

With regard to FIG. 1, a computer keyboard 11 has a full complement of alphanumeric keys 12, a numerical keypad 13, and a row of function keys 14 adjacent to the top edge 16 of the keyboard. This keyboard layout is typical but not necessarily limiting. The keyboard 11 also includes opposed sides 17 and a bottom edge 18. A salient feature of the keyboard 11 is the provision of an ultrasonic user presence detector 21 projecting upwardly from the upper surface of the keyboard. The detector 21 is located in an area of the keyboard that is adjacent to the corner formed by the top edge 16 and one of the sides 17.

The detector 21 has a beam axis A along which the ultrasonic beam is generated, and thus defines the direction of maximum sensitivity of the detector 21. The axis A is directed at an elevation angle of approximately 20° (with respect to the horizontal surface that supports the keyboard). Furthermore, the detector is rotatable about a generally vertical axis through the range of azimuth positions that a typical user would occupy while using the keyboard. Thus, as shown in FIG. 1, the axis A₁ of the detector may be directed along a line that intersects the central portion of the keyboard user's body B₁ (the head and torso as viewed from above) when the user is generally centered in front of the keyboard, thus forming an included angle of approximately 35° with an axis M that bisects the top and bottom edges of the keyboard 11. However, the user may move laterally to the left (as seen in FIG. 1) to a new position B₇, in which the user's right hand may operate the keyboard 11 while the left hand is used for other tasks; e.g., operating another electronic or medical device, holding a telephone receiver, or the like. In such circumstance the detector 21 may be rotated by the user so that the detector axis (A₂) remains directed to the central portion of the user's body B₇, thus forming an included angle of approximately −20° with the transposed axis M. This angular range is illustrative rather than limiting in scope, and is provided to suggest a practical range of rotation for diverse keyboard uses.

The keyboard may also be provided with built-in security devices 25, such as a fingerprint reader or other biometric or electromagnetic user authentication devices, so that a user may be verified before the system grants access through the terminal After verification and log-in, the ultrasonic user presence detector operates continuously to assure that the user has not departed from the vicinity of the keyboard 11. Following a successful log-in to the system, if the user moves laterally in front of the keyboard the detector 21 may be rotated to remain directed at the user and avoid an unintended log-out event. As soon as user presence is no longer detected (or after a preset time delay to avoid false negative actions), the ultrasonic detector will send a signal through the same channel used by the keyboard to communicate with the computer system. The UPD signal will cause the computer system to log out of the user access mode at the terminal served by the keyboard 11, so that the opening into the system is quickly blocked before snooping or hacking can occur.

The detector 21 may be located at other positions on the keyboard, such as the medial area adjacent the top edge, or at the top edge corner opposed to the one shown, as long as it is supported by the keyboard itself and is aimable at the expected range of positions of the user at the keyboard.

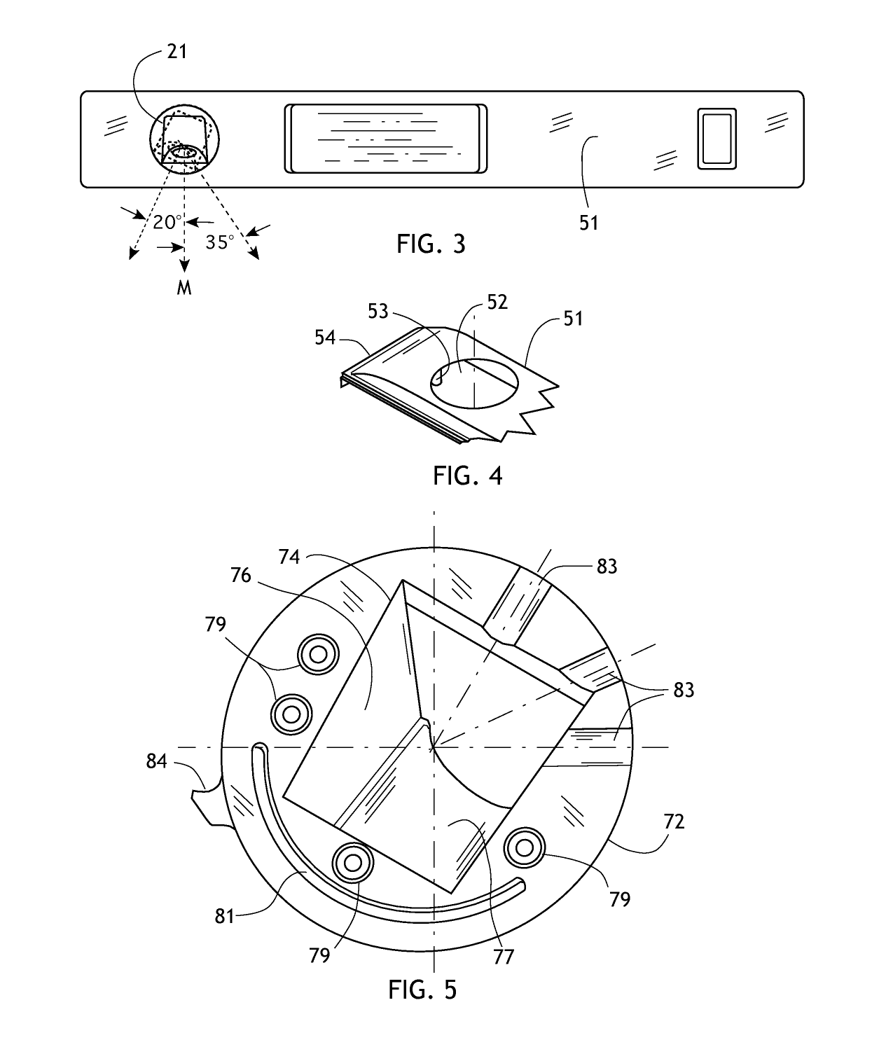

With regard to FIGS. 3 and 4, another embodiment of the invention provides a keyboard assembly having a unique modular system designed to have flexible interchangeable tops 51 to accommodate various discrete input technologies, as described in copending U.S. application Ser. No. 13/652,732, filed Oct. 16, 2012, which is incorporated herein by reference in its entirety. Each cover 51 has a rectangular plan layout that fits in complementary fashion over an opening in the keyboard assembly that extends laterally therein adjacent to the uppermost row of keys. Furthermore, the interchangeable covers 51 are provided with features that either embody portions of the security sensor modules, or accommodate modules placed in the keyboard assembly, or enable communications to the module(s).

In addition, any of the interchangeable covers 51 may support an ultrasonic user presence detector 21. For this purpose, a cover 51 may be provided with a circular opening 52 adjacent to one end 54 thereof. A plurality of standoffs 53 depend from the inner surface of the cover 51 and are arrayed about the opening 52 in particular positions to support the detector assembly 21, as described below.

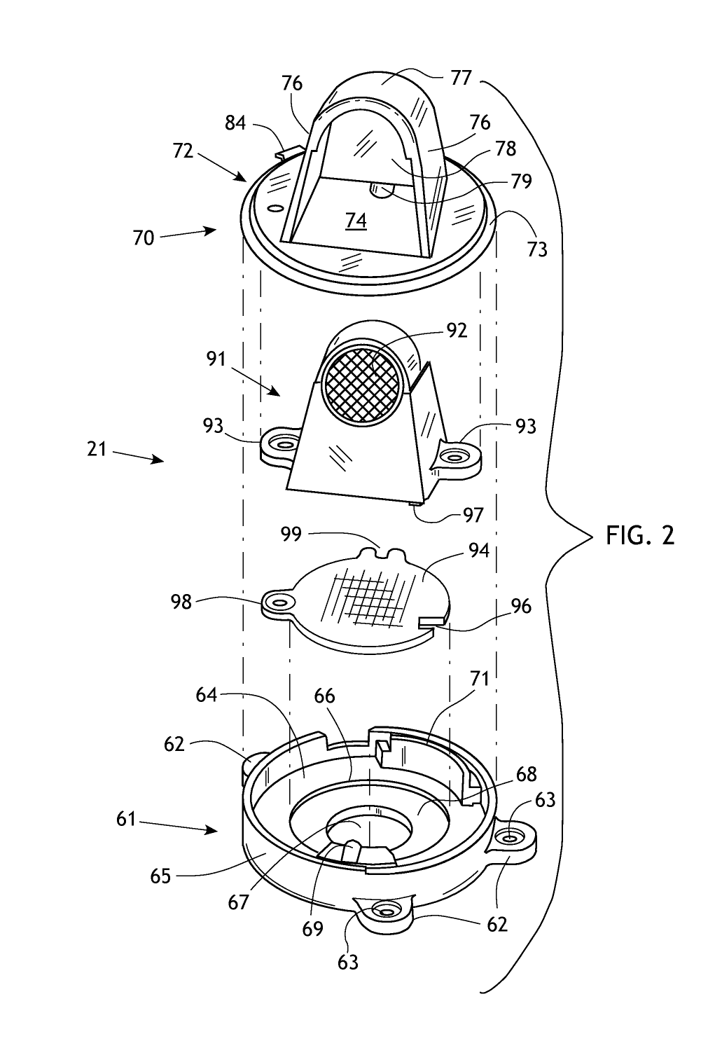

With regard to FIG. 2, the UPD assembly 21 includes a support base 61 having a generally flat cylindrical configuration, with a trio of tabs 62 extending radially outwardly therefrom. Each tab 62 includes a mounting hole 63 for securing the tab to a respective standoff 53 with screws or other fasteners, so that the base 61 is in effect secured to the underside of the cover 51 and centered with respect to opening 52. The base includes a cylindrical sidewall 65 that defines an outer annular flat 64 extending perpendicular to the cylindrical axis. A stepped annular shoulder 66 defines an inner annular flat 68, and there is a central opening 67 extending axially through the base 61. Protruding upwardly from the outer annular flat 64 is a spring arm 69 that is integrally molded with the other structures of the base 61. An annular guide track 71 is disposed concentrically within a portion of the sidewall 65 and protruding axially from the annular flat 64. The guide track 71 subtends an angle that is substantially similar to the rotational freedom of the detector 21, as described below.

The UPD assembly 21 further includes an outer housing 70 having a disk-like base 72 with a stepped annular periphery defining an outer flange 73. The base 72 is disposed with the stepped periphery extending close-fit through the opening 52 in cover 51 in slidable rotating fashion, and the outer flange 73, which is wider than the diameter of opening 52, is disposed within the cover 51. This engagement prevents removal of the UPD assembly 21 from the cover 51. With additional reference to FIG. 5, the base 72 includes a quadrilateral opening 74, and a pair of opposed sidewalls 76 extend upwardly from opposed sides of the opening 74. A cylindrically arched top 77 joins the sidewalls 76, and rear end wall 78 spans the sidewalls and top. The sidewalls 76, end wall 78 and arched top 77 define an enclosure that extends upwardly from the cover 51 and has a front opening.

The bottom surface of the base 72 is provided with a plurality of fastener pads 79 depending from the lower surface of the base and having holes for screw fasteners or the like. An arcuate channel 81 is formed in the lower surface of the base 72 and configured in complementary fashion to guide track 71. The guide track is engageably in the channel 81 in slidable fashion, and serves to guide and limit the angular extent of rotation of the assembly 21. The lower surface of the base is also provided with a plurality of shallow grooves 83 extending generally radially with respect to the common cylindrical axis. The grooves are positioned to be snap-engageable with a detent pad supported on the spring arm 69, thereby providing a position-click detent at selected angular excursions of the housing. For example, the grooves 83 may be positioned to define the +35° and −20° limits of angular motion of the housing, as well as a midpoint such as 0°. Other angular settings made be made by changing the angular spacing of the grooves 83, as needed for particular keyboard uses and applications.

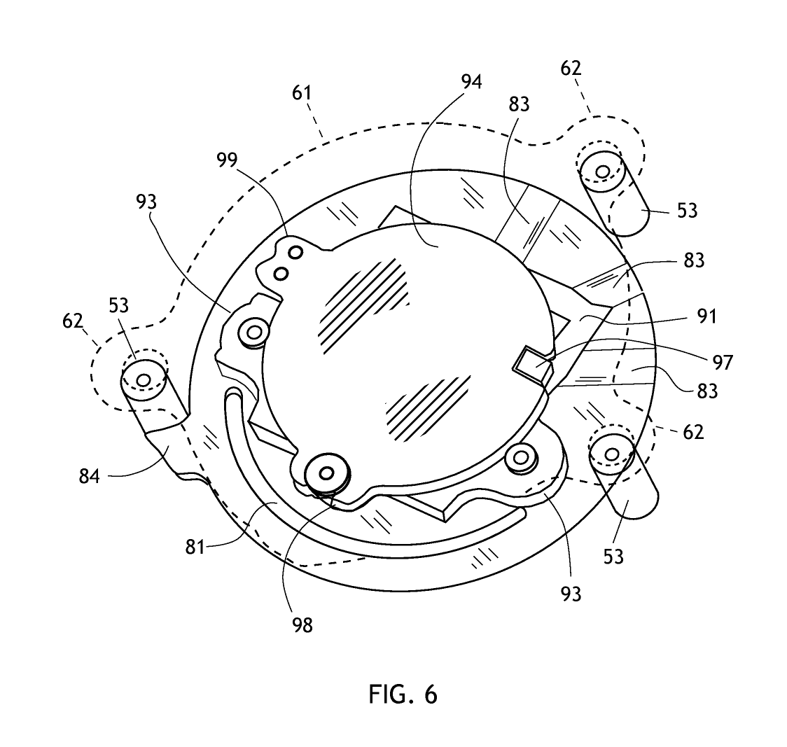

Extending outwardly from the outer flange 73 is a stop lug 84 that is positioned to impinge on one of the standoffs 53 to provide a positive stop for angular motion of the detector 21 at its designed limit of rotation, as shown in FIG. 6.

Another component of the UPD assembly 21 is an ultrasonic transceiver assembly 91 having a disk-like active transceiver face 92. The enclosure 76-78 of the outer housing is formed in complementary fashion to the ultrasonic transceiver assembly 91 to surround the assembly 91 and expose the transceiver face 92 to emit an acoustic beam as shown in FIG. 1. A pair of mounting tabs 93 extend outwardly from opposed sides of the device 91, and are positioned to register with two of the fastener pads 79, so that device 91 may be joined fixedly to the outer housing 70. The device 91 is also mounted on and secured to an underlying PCB 94 that connects to and drives the ultrasonic transceiver assembly. The PCB 94 includes a keyway 96 that engages a lug 97 (FIG. 6) extending from the bottom of the assembly 91, so that the PCB and the assembly 91 are locked in a fixed angular relationship about the cylindrical axis. A mounting tab 98 extends radially from the PCB and is disposed to register with one of the fastener pads 79 to secure the PCB 94 to the outer housing 70. Another tab 99 extending from the PCB enables electrical connection to the circuitry and thus to the device 91. The PCB 94 is located within the recess formed by annular shoulder 66, and the tabs 93 are located within the recess formed by the sidewall 65.

To summarize the assembly of components, the ultrasonic transceiver assembly 91 is mounted on the PCB 94, and that assembly is secured to the outer housing 70 by means of mounting tabs 93 and 98. The outer housing 70 is oriented with the enclosure portion 76-78 extending upwardly through opening 52 and flange 73 slidably engaging the inner periphery of opening 52. The support base 61 is secured by tabs 62 to standoffs 53 to support the assembly of components 70, 91, and 94. The annular guide track 71 engages the arcuate channel 81 of the outer cover base 72 to guide rotational motion of the outer housing 70 and its assembled components 91 and 94, and the spring arm detent 69 is engageable with one of the shallow grooves 83 to comprise a position-click detent to indicate to the user particular angular settings. The stop lug limits rotation of the assembly in one direction, and the guide track 71 riding in the channel 81 limits rotation of the assembly in the other direction. The support base 61 supports the assembly of components 70, 91, and 94 from below in rotatable fashion, and the outer flange 73 prevents removal of the assembled components upwardly from opening 52, thus prevent removal while permitting rotation of the UPD 21 to various angles to maintain the aim of the axis of the detector 21 toward the user at the keyboard, as described previous with respect to FIG. 1.

The construction described above with reference to FIGS. 2-6 is substantially the same for the embodiment of FIG. 1, with the exception that a custom modifiable cover 51 is not used, and the opening 52 is formed in the upper surface of the housing of keyboard 12.

It may be noted that the detector 21 may be placed at any location on the keyboard that is convenient and available, and the angular range of azimuth angle may be set to encompass the expected range of motion of a keyboard user. Likewise, the elevation angle may be selected empirically to suit the keyboard user and the tasks being undertaken while positioned at the keyboard.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In a computer terminal that includes a keyboard connected to a computer through a communications channel, subject to a user log-on authentication process, an improved keyboard comprising:
at least one user identification module secured within and connected to the keyboard, each identification module capable of carrying out a respective log-on user authentication process;
a user presence detector supported on an upper surface of the keyboard in rotatable fashion, said user presence detector having a detector axis, said detector being rotatable to direct said axis toward a range of expected locations of a user at the keyboard, said user presence detector generating a user-absent signal when no user is detected at said expected location; and,
said computer terminating the connection of the terminal to the computer following a predetermined time delay after said user-absent signal is received.

2. The computer keyboard construction of claim 1, wherein said user presence detector comprises an ultrasonic transceiver having an acoustic output that is aligned with said detector axis.

3. The computer keyboard construction of claim 1, wherein said detector axis has a generally fixed elevation and a variable azimuth angle through a predetermined angular range.

4. The computer keyboard construction of claim 1, further including an opening formed in said upper surface of said keyboard, and said user presence detector includes an outer housing projecting upwardly through said opening in rotatable fashion.

5. The computer keyboard construction of claim 4, further including a support base secured within said keyboard in registration with said opening, said outer housing being supported in rotatable fashion from below by said support base.

6. The computer keyboard construction of claim 5, wherein said outer housing includes a disk-like housing base having an outer flange greater in diameter than said opening to retain said housing base within said keyboard.

7. The computer keyboard construction of claim 6, wherein said support base includes an annular guide track extending toward said disk-like housing base, and an arcuate channel formed in said disk-like housing base and disposed to engage said annular guide track in complementary fashion to guide rotational motion of said outer housing.

8. The computer keyboard construction of claim 6, wherein said support base includes a spring detent arm extending therefrom toward said disk-like housing base, and at least one groove formed in said disk-like housing base and disposed to snap-engage said spring detent arm as a position-click detent at a predetermined azimuth angle of said outer housing.

9. The computer keyboard construction of claim 6, further including at least one stop lug projecting from said outer housing and disposed to impinge on a portion of said support base at a predetermined azimuth angle of said outer housing.

10. The computer keyboard construction of claim 6, further including a plurality of standoffs extending between said support base and said keyboard, and at least one stop lug projecting from said outer housing and impinging on at least one of said plurality of standoffs.

11. The computer keyboard construction of claim 3, wherein said fixed elevation angle is approximately 20° above horizontal.

12. The computer keyboard construction of claim 3, wherein said variable azimuth range is approximately −20° to +35° with an axis M that bisects a bottom edge of the keyboard.
